(19) United States
(12) Patent Application Publication
(10) Pub. No.: US 2011/0274515 A1
(43) Pub. Date: Nov. 10, 2011

(54) Plugs With Dimensional Tolerance Absorbing Hold-In Surfaces

(75) Inventor: Robert J Pelc, JR., Bradenton, FL (US)

(73) Assignee: R & B MARKETING CORPORATION, Gaffney, SC (US)

(21) Appl. No.: 13/144,563

(22) PCT Filed: Jan. 14, 2010
(86) PCT No.: PCT/US10/21036

§ 371 Date: Jul. 14, 2011

Related U.S. Application Data
(60) Provisional application No. 61/145,458, filed on Jan. 16, 2009.

(51) Int. Cl. F16B 37/14

(52) U.S. Cl. 411/372.5

(57) ABSTRACT

A plug offering a variety of dimensional tolerance absorbing properties providing for a strong hold-in plug force or outward pressure against the side wall of the drilled hole into which a plug is placed These properties come a textured surface produced by surface protuberances and/or recesses that are shaped and/or sized to provide the required hold-in force The positioning of the protuberances and/or recesses also contributes to the required hold-in force The protuberances may be ridges that make-up a series of radial concentric spaced protruding rings oriented perpendicular or parallel to the plugs axial direction of the plug The plugs come in a multitude of shapes including straight, tapered, concave, convex, stepped, wavy, any combination thereof, and/or free-form sides and round, elliptical, square, rectangular, oblong, triangular, polygonal, wavy, or any combination thereof bottom or top ends

### CROSS-REFERENCE TO RELATED APPLICATIONS

### Statement Regarding Federally Sponsored Research or Development

Not Applicable

### REFERENCE TO SEQUENCE LISTING, A TABLE OR A COMPUTER PROGRAM LISTING COMPACT DISK APPENDIX

Not Applicable

### BACKGROUND

The present invention relates generally to plugs and, more particularly, to plugs with dimensional tolerance accepting surfaces.

The background information discussed below is presented to better illustrate the novelty and usefulness of the present invention. This background information is not admitted prior art.

Wood plugs are standard means used to conceal the holes caused by the use of recessed screws or nails as, for example, when decking floor boards are attached to their support studs in the construction of decks, in the making of furniture, wood floor installation, and the like. Presently available plugs are commonly short pieces of wooden dowel that fill a hole drilled to accommodate the use of a screw by applying glue to the end of the wooden dowel that is to be inserted into the hole to be filled and then pounding the glued wooden piece into the screw hole to be filled. After the glue has hardened, the projecting part of the wooden plus is trimmed flush with the wood surface into which the screw was inserted, if necessary.

### SUMMARY

The presently available wooden plugs that are used to hide the unsightly recesses associated with screw or nail holes in wooden surfaces have many negative aspects. These contribute to both a waste of time and an increase in job cost during. Even for a somewhat small-sized project, such as the construction of a small deck, typically hundreds or thousands of plugs are required. The present Inventor watched his installers struggling with improperly sized and/or shaped plugs that are either too loose or too tight for the holes into which they are to be installed. Once installed, the ineffective plugs often pop out of their holes as the glue used to ostensibly seal them into the hole expands upon drying causing the plugs to break as they are forced into the holes. After extensive study and research, the Inventor identified a number of individual structural problems that result in the many drawbacks in the use of such wood plugs to conceal screw holes in deck surfaces, floors, hand railings, and stairs.

The installation of a standard plug starts when a hole in which a screw or nail is to be inserted is typically drilled using a powered hand held drill. Installers must frequently slow down the hole drilling process in order to attempt to achieve a more uniform hole to try to make traditional plugs fit the hole. Most often, the installer cannot hold the drill perfectly straight during the process and instead of a perfectly round hole being drilled a slightly elliptical hole is formed as the drill inadvertently wobbles. The resulting hole may often be elliptical because the drill bit may not be completely straight and the drill bit holding chuck bearings or fittings may not be centered properly. As plugs are made to be round, a slightly elliptical hole further complicates the installation of the traditional round wood plug. Traditional wood plugs are often designed to have sidewalls tapered a few degrees and/or they are designed to be oversized slightly in an attempt to provide for a snug fit. This tapering and over sizing of plugs, however, often results in the creation of additional problems. For example, if the plug is too large for the hole that was drilled, it is likely to break apart as it is being forced into the hole with a hammer and/or the edges around the hole may be damaged. When the standard plug diameter is reduced, it often is reduced too much and, thus, cannot fit securely in the drilled hole, thus allowing the glue to push the plug out of the hole during the glue curing process. When the plug is more closed fitted to the hole into which the plug is to be inserted, a gap is often formed around part or all of the plug surface, which results in an aesthetic detraction instead of the intended aesthetically-pleasing concealed look. This poor appearance is very often further exaggerated by the sometimes elliptical, instead of round, holes that are frequently drilled, as mentioned above. The use of the traditional non-tapered straight plug, also poses improper fit problems, as the hole and the plug diameter are rarely a perfect match due to the machining tolerances of the plug and the drilling tolerances of the holes. These problems are exacerbated when the plugs increase or decrease in diameter, which happens as the plugs age or are exposed to moisture before being installed. Improperly fit plugs often push up and out of the aperture over time which can create tripping hazards on walking surfaces, unsightly imperfections in finished products, and can require costly repairs.

Accordingly, the inventor has developed a set of principles such that when plugs made following the principles are used to fill-in holes, each plug exhibits dimensional tolerance acceptance that provides a strong hold-in force or outwardly directed pressure against the side wall of the drilled hole into which the plug is placed. This hold-in force maintains the plug in the hole even when glue is, or is not, used. To achieve a plug having a desired dimensional tolerance acceptance that provides a strong hold-in force the inventive principles require that each plug has a textured surface, that is most usually a side surface, but could be also, or instead, a top and/or bottom surface. The texture usually is a product of outwardly projecting protuberances about the circumferential side of the plug. The designs of the protuberances depend on the specific application. The protuberances can be protruding radial ridges, The orientation of the ridges can be circumferential, that is, aligned perpendicular to the axial direction of the plug, aligned parallel to the axial direction of the plug, or have a wave form, for example. The protuberances are continuous ridges about the side of the plug or are individual knobs, bulges, or nodes, or a combination thereof. The protuberances may occur evenly, randomly, or sporadically about the sides of a plug. Plugs most often have their protuberances occurring on the side of the plug, but may, if required have protuberances occurring on the top and/or bottom of the plug. Each protuberance is distinct and separate from adjacent protuberances. The plugs on which are found the protuberance are produced in any desired shape. The may be round, straight sided, or tapered. Plugs of this invention may be angled to various degrees, that is, besides the more typical round plug, plugs come in square, winged, and oval shapes, for example. Plugs can have the wood face grain displayed on either the sides or ends of a plug. The type of plug used and how it is installed can make a big difference in the finished look. For instance, most store-bought plugs are cut from the end of a dowel, which means that the ends of the plugs display wood end grain. Having an end grain exposed on the end of the plugs of the present invention would present a grain that is different from the grain of the floor boards which would make the plugs stand out and present an unsightly or careless look to the finished job. Moreover, plugs with end grain exposed on their ends absorb stain or finish like a sponge. This makes the plugs darker than the surrounding wood so they end up standing out like a sore thumb. Additionally, exposed end grains suck up moisture hastening the aging and rotting of the wood. In general, all buttons and plugs are assumed to be end grain unless side/face grain is specified. Side/Face grain though should be used consistently in the stair, furniture, and flooring industries, so that the plugs match the grain of the wood in which they are inserted. The plugs of the present invention are always cut so that the ends of the plugs display the face grain of the wood.

### BRIEF DESCRIPTION OF THE DRAWINGS

In order that these and other objects, features, and advantages of the present invention may be more fully comprehended and appreciated, the invention will now be described, by way of example, with reference to specific embodiments thereof which are illustrated in appended drawings wherein like reference characters indicate like parts throughout the several figures. It should be understood that these drawings only depict preferred embodiments of the present invention and are not therefore to be considered limiting in scope, thus, the invention will be described and explained with additional specificity and detail through the use of the accompanying drawings, in which:

FIG. 1a is an elevation view of a plug according to the principles of the present invention.

FIG. 1b is a perspective top and side view of the plug, as shown in FIG. 1.

FIG. 2a is a series of elevation views illustrating various tolerance absorbing ring designs for the plugs of the present invention.

FIG. 2b is a series of plan views illustrating the various body and end shapes of the plugs according to the present invention.

FIG. 2c consists of plan views illustrating alternative designs for the tolerance absorbing plug rings.

FIG. 2d is an elevation view of a plug to illustrate the terminology used herein.

FIG. 3a is an enlarged view of the invention in use, as shown in FIG. 3b.

FIG. 3b is a small scale view of the invention as shown in FIG. 3a.

### A LIST OF REFERENCE NUMBERS AND THE PARTS TO WHICH THEY REFER

2 Top surface of plug 10, also referred to as a plug end.
4 Side surface of plug 10, also referred to as the plug was.
6 A series of concentric ridged rings projecting from the plug wall 4.
8 A series of concentric recessed rings in plug wall 4.
10 A plug.
12 Largest diameter ridged ring.
14 A screw.
16 A floorboard.
18 A joist.
20 A recess.
22 Face grain on end of plug.
24 End grain on side of plug.

### DEFINITION

Concentric objects, as used herein, refer to a set of objects that each share the same center, axis, or origin, but are sized so that each object in the series has a radius larger or smaller than the object adjacent to it. An example of a concentric series of inscribed ringed recesses would be the recesses inscribed into the outer side surface of a plug.
Dimensional tolerance absorbing or accepting structured plug, as used herein, refers to a plugs ability to accommodate the differences in tolerance that regularly occur in the drilling of the hole into which a plug is to be inserted or could even occur in the making of a plug. The structure of such a structured plug provides a strong “hold-in” force or outwardly directed pressure against the side wall of the drilled hole into which the plug is placed to hold-in the plug. This hold-in force maintains the plug in the hole when glue is, or is not, used.
Tolerance or Dimensional tolerance, as used herein, refers to the permissible range of variation in the dimension of an object.

It should be understood that the drawings are not necessarily to scale. In certain instances, details which are not necessary for an understanding of the present invention or which render other details difficult to perceive may have been omitted.

### DETAILED DESCRIPTION

Referring now, with more particularity, to the drawings, it should be noted that the disclosed invention is disposed to embodiments in various sizes, shapes, and forms, as are described below or shown in the drawings. Therefore, the embodiments described herein are provided with the understanding that the present disclosure is intended as illustrative and is not intended to limit the invention to the embodiments described.

As stated above, installers are familiar with the inconveniences posed by the commonly available wooden plugs that are used to fill the recessed holes remaining after the insertion of screws to attach boards to their support joists. After investigating all of the variables that are present during the plugging operation, such as the shape and size of both the wooden plugs, the shape, size, and orientation of the hole that is drilled to receive the attaching screw or nail and the plugs, and the method and means used to drill the hole, the present Inventor identified several reasons for the problems. Relying on his analysis of these variables, the Inventor developed a set of principles that, when followed, make the plugs of the present invention. Thus, the plugs, as taught herein, either eliminate the identified problems or compensate for the causes that cannot be eliminated by a new plug design. When plugs made following the principles of the present invention are used to fill-in recessed screw holes, each plug exhibits a strong hold-in force or outwardly directed pressure against the side wall of the drilled hole into which the plug is placed to maintain the plug in the hole even when glue is not used. The hold-in force is provided by designing each plug to have a tolerance accepting surface. In general, the principles require each plug to have a textured surface that in most, but not all, cases comprise outwardly projecting protuberances about the circumferential side of the plug. The protuberances include ridges and nodes. The orientation of the ridges can be circumferential, that is aligned perpendicular to the axial direction of the plug, aligned parallel to the axial direction of the plug, or have a wave form, for example. The protuberances are continuous ridges about the side of the plug or are individual knobs, bulges, or nodes, or a combination thereof. The ridges may be spaced with relative regularly or irregularly with regard to one another. The ridges may cross each other. The plugs are produced in any required form. The plugs may be round with their sides straight or tapered. If needed, plugs of this invention may be angled to various degrees, that is, besides the more typical round plug; some plugs are square, some winged, and some oval, for example. The protuberances may occur evenly, randomly, or sporadically about the sides of a plug. Plugs most often have their protuberances occurring on the side of the plug but, if required, the plugs may have protuberances occurring on the top and/or bottom of the plug. Some special needs include plugs with ridges or protuberances on only one area of a plug.

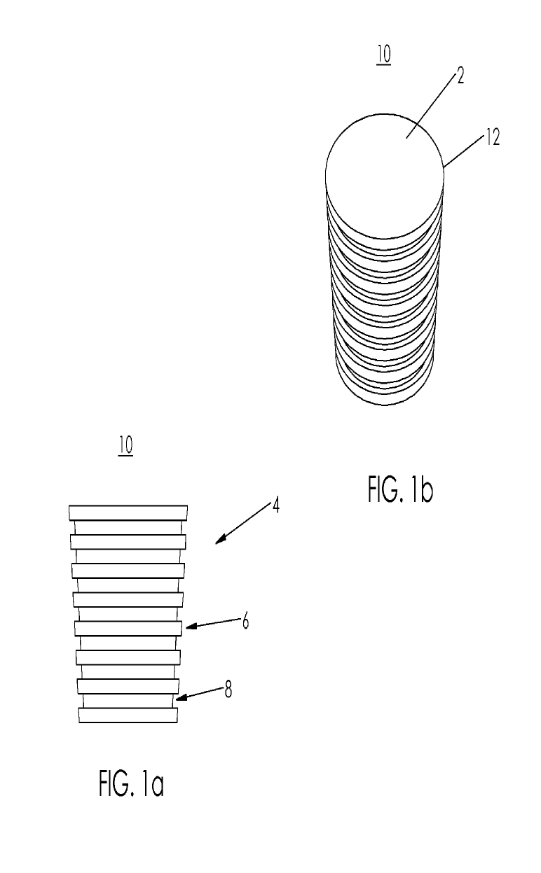

FIG. 1a, an elevation view, and FIG. 1b, a perspective view, illustrate one example of a plug made according to the principles of the present invention. Plug 10 has a series of spaced recesses 8 that occur between each set of concentric, outwardly radially projecting, tolerance absorbing ringed ridges 6 about side surface 4 of plug 10. In this illustration, ringed ridge 12 has the greatest diameter as it forms the defining outer edge of top surface 2. The set of ringed ridges 6 decreases in diameter from ring ridge 12 toward the bottom of the plug. Thus, one method of making such a “ringed” plug, involves sculpting a series of spaced recesses into the side of an otherwise relatively smooth-sided plug to produce a series of outwardly projecting, dimensional tolerance absorbing, ringed ridges where each ringed ridge is distinct and separate from adjacent ringed ridges. Such ringed ridges are referred to as “hold-in” rings or protuberances. Regardless of the process of making, such dimensional tolerance absorbing features provide a firm hold-in power for the plug, acting much like barbs on a fish hook to hold each plug in its hole. Increased hold-in power is achieved by this style of plugs even when the hole is improperly fitted or slightly elliptical, as is often the case in holes drilled by hand on the jobsite or in a small workshop. Depending upon the material from which a plug is made, the hold-in protuberance design provides for plugs to be installed without glue, thus eliminating the messy, costly, and time-consuming requirement of gluing the plug into a hole. Eliminating the glue is made possible by the high hold-in force the protuberances of the plug exert against the inner side wall of the drilled hole. It should be noted that standard plugs often pop out of the hole when glue is not used due to an improperly sized hole, moisture in the plug, or old plugs, for example. Additionally, standard plugs are also forced out of their hole when glued when the glue is polyurethane based glue. Polyurethane based glues expand as they dry; forcing many improperly sized traditional plugs out of the hole which they are plugging. When this happens some of the glue is deposited onto the finished surface resulting in unsightly surface staining. The hold-in ring plugs made according to the principles of the present invention are more consistently held in place when glue is, or is not, used with the plug.

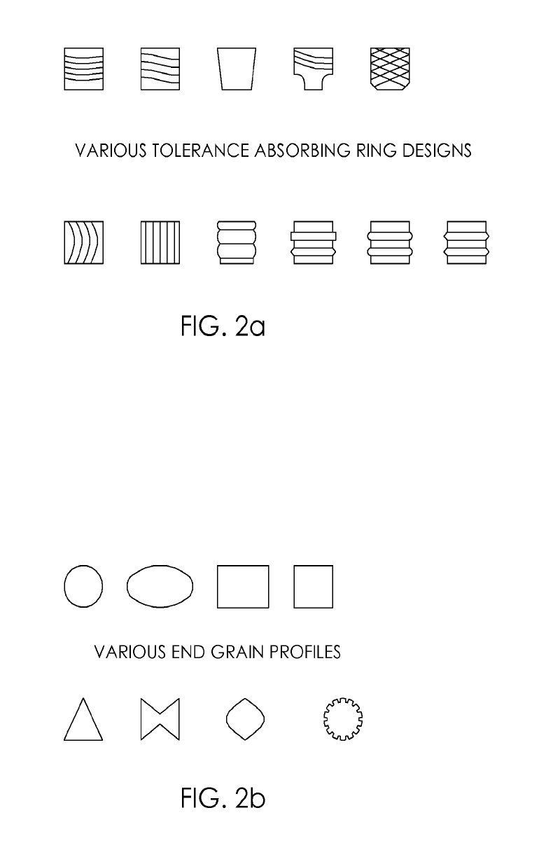

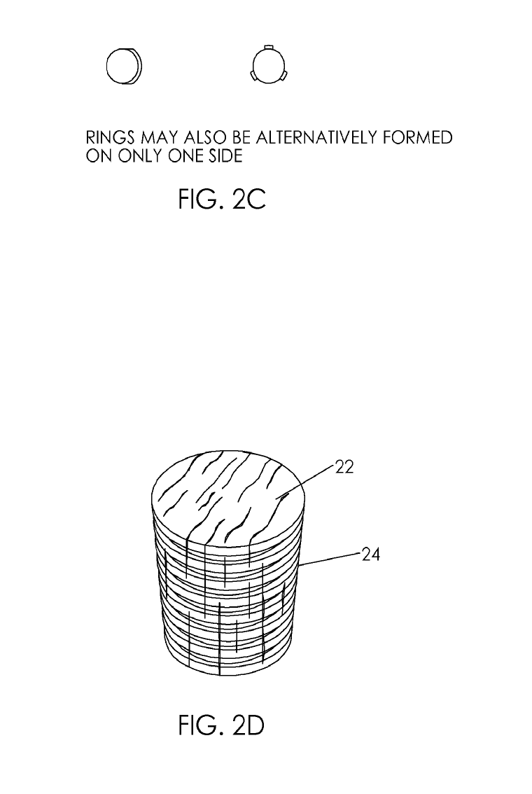

FIG. 2a, a series of elevation views, illustrates a number of dimensional tolerance absorbing protuberance designs that may be used according to the principles of the present invention in addition to the design shown in FIGS. 1a and 1b. It should be appreciated that the projecting rings or ridges of the present invention need not conform to the general notion of a ringed ridge. The principles of the present require each plug to have a textured side surface. In the examples given in the drawings, the texture comprises the hold-in protuberances with which each plug is provided. The hold-in protuberances are formed having a variety of shapes and/or dimensions to achieve different levels of tolerance absorption and hold-in power, as required. That is, some of the protuberances project further out than others, or conversely the recesses can be recessed-in further to depths that are dictated by need. Some of the designs include protuberances that are parallel to the axial direction of the plug, while others have protuberances that are perpendicular to the axial direction of the plug, other protuberances are at various angles to the axial direction of the plug, and some plugs have protuberances oriented in a combination of angles. The textured surface of the plugs compensate for elliptically-drilled holes or improperly-sized holes. Plugs having the dimensional tolerance absorbing textured surface of the present invention are able to conform to non-round or slightly improperly sized holes to reduce any gap that would be formed around a merely smooth sided round plug. The dimensional tolerance absorbing structured plug surface may compress on one side of the elliptical hole and stay expanded on the opposing side to achieve the much desired aesthetic look of a plug that does not have any gap around it. The configurations of the plug's surfaces also help to retain glue in the hole, thus reducing or eliminating glue being squeezed out onto the workpiece surface during the glue curing process. Reducing or eliminating glue squeeze-out is an important time saving achievement for plug installation as it reduces unnecessary sanding of the surface and keeps the work surface from being stained by the glue. The hold-in plug construction further assists in holding the plug firmly in the hole as the plug expands and/or contracts due to the absorption and/or desorption of moisture during seasonal and weather changes. Hold-in protuberances come in various shapes including square, round, pointed, wavy, free-form, and elliptical designs. The protuberance may be consistently or sporadically spaced. There may be rings of ridges around part or the entire perimeter of the plug. The rings may be a combination of different shapes or sizes used in conjunction on the same device. Each protuberance may vary in size on different sides of the device. The protuberance may be vertical, horizontal, diagonal, wavy, congruent, and incongruent, any multiple combinations thereof, and/or free-form. The protuberances may be single or multiple and may resemble knobs or bulges. In summary, the hold-in protuberances of plugs made according to the principles of this invention are designed to meet various needs.

FIG. 2b, a series of plan views, illustrates the various body shapes of the plugs according to the present invention. Each of the body shapes may be manufactured having the protuberances as described above. Variations of the present invention include dimensional tolerance absorbing protuberances formed on plugs with sides that are straight, tapered, concave, convex, stepped, and wavy, any combination thereof, and/or free-form. The shape of the plug's end may be round or elliptical, but variations also include square, rectangular, oblong, triangular, polygonal, wavy, or any combination thereof.

FIG. 2c, two plan views, illustrates additional alternative designs for the tolerance absorbing plug protuberances. Plugs, according to the principles of the present invention, may provide required holding power by being shaped to have protuberances on one side of a plug, or on several sides of a plug, as shown. FIG. 2d illustrates a view of a commonly-shaped plug to further explain the terms used herein and illustrates the face grain displayed on the end of the plug and the end grain on the side of the plug. Face grained plug ends tend to absorb stain at the same rate as the surrounding wood for a less obtrusive finish of the finished floor unlike traditional end grain wood plugs which can turn darker when stained. Moreover, face grained plugs do not absorb moisture as do end grained plug ends.

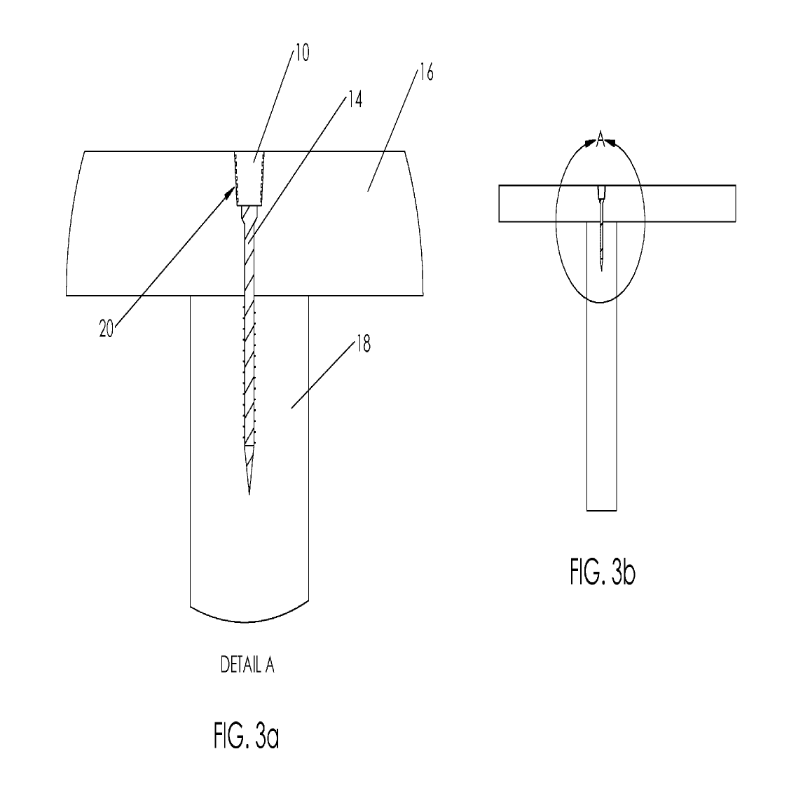

FIG. 3a, an enlarged view of the invention shown in FIG. 3b, illustrates a plug 10 of the present invention plugging a recess 20 that remains after using screw 14 to fix floorboard 16 to joist 18. One preferred embodiment would use a wooden face grain plug, but other preferred embodiments include variations may include plugs cut or formed from wooden end grain material, composite, plastic, ceramic, metal, or any combination.

The foregoing description, for purposes of explanation, uses specific and defined nomenclature to provide a thorough understanding of the invention. However, it will be apparent to one skilled in the art that the specific details are not required in order to practice the invention. Thus, the foregoing description of the specific embodiment is presented for purposes of illustration and description and is not intended to be exhaustive or to limit the invention to the precise form disclosed. Those skilled in the art will recognize that many changes may be made to the features, embodiments, and methods of making the embodiments of the invention described herein without departing from the spirit and scope of the invention. Furthermore, the present invention is not limited to the described methods, embodiments, features or combinations of features but include all the variation, methods, modifications, and combinations of features within the scope of the appended claims. The invention is limited only by the claims.

What is claimed is:

1. A product, comprising:
a plug having a textured surface so as to provide the plug with dimensional tolerance absorption capacity and a strong hold-in force or outwardly directed pressure against a side wall of a drilled hole into which said plug is placed.

2. The product, as recited in claim 1, further having a top, bottom, and side surface, wherein said side surface is a side textured surface.

3. The product, as recited in claim 1, wherein said textured surface comprises protuberances and/or recesses on said textured surface.

4. The product, as recited in claim 1, wherein said textured surface comprises protuberances, where each said protuberance is distinct and separate from all other protuberances on said textured surface.

5. The product, as recited in claim 2, wherein said side textured surface comprises protuberances and/or recesses.

6. The product, as recited in claim 3, wherein said protuberances comprise outwardly projecting ridges.

7. The product, as recited in claim 6, wherein said ridges are oriented perpendicular to the axial direction of the plug.

8. The product, as recited in claim 6, wherein said ridges are a series of radial concentric spaced protruding rings.

9. The product, as recited in claim 6, wherein said ridges are oriented parallel to the axial direction of the plug.

10. The product, as recited in claim 6, wherein said ridges are oriented at angles other than 90 degrees and 180 degrees to the axial direction of the plug.

11. The product, as recited in claim 6, wherein said top and bottom surface of a plug display the face grain of the wood from which they are produced.

12. The product, as recited in claim 3, wherein said protuberances comprise square, round, pointed, wavy, free-form, elliptical shapes and/or be of free-form shapes.

13. The product, as recited in claim 12, wherein said protuberances may be oriented in a vertical, horizontal, diagonal, congruent, incongruent, any multiple combination thereof manner on said plug.

14. The product, as recited in claim 3, wherein said protuberances are consistently or sporadically spaced.

15. The product, as recited in claim 3, wherein said protuberances are spaced about the entire perimeter or only a part of the entire perimeter of the plug.

16. The product, as recited in claim 3, wherein said protuberances may be a combination of different shapes or sizes used in conjunction on the same plug.

17. The product, as recited in claim 1, wherein said plug may comprise a body shaped to be straight, tapered, concave, convex, stepped, wavy, any combination thereof, and/or free-form sides.

18. The product, as recited in claim 2, wherein said bottom or top end plug may be round, elliptical, square, rectangular, oblong, triangular, polygonal, wavy, or any combination thereof.

19. A product, comprising:
a dimensional tolerance absorbing structured plug having textured surface so as to provide the plug with dimensional tolerance absorption capacity so as to provide the plug with a strong hold-in force or outwardly directed pressure against the side wall of the drilled hole into which the plug is placed;
said plug having a top, bottom, and side surface, wherein any of said surfaces may be said textured surface;
said textured surface comprises protuberances and/or recesses on said textured surface.

20. A product, comprising:
a plug having a top, bottom, and side surface,
said top and bottom surface display face grain,
at least one surface is a textured surface;
said textured surface comprises protuberances and/or recesses;
said protuberances being a series of radial concentric spaced protruding ringed ridges;
said ridges being oriented parallel and/or perpendicular to the axial direction of the plug;
so that upon insertion into an aperture said plug exhibits dimensional tolerance absorption capacity and also exhibits outwardly directed pressure against the side wall of the aperture into which said plug is inserted so as to provide for a strong hold-in force.
